(19) United States
(12) Patent Application Publication
(10) Pub. No.: US 2024/0141556 A1
(43) Pub. Date: May 2, 2024

(54) Process for Making Garments from Recycled Dope-dyed Synthetic Yarns Containing Recycled Carbon Black

(71) Applicant: Heng-Wen Shiue, Wujie (TW)

(72) Inventor: Heng-Wen Shiue, Wujie (TW)

(21) Appl. No.: 17/975,615

(22) Filed: Oct. 28, 2022

(51) Int. Cl. D01F 1/10; B32B 5/02; B32B 5/26; B32B 37/16; C08J 3/22; C08K 3/04; C09C 1/48; D01D 5/04; D01D 5/08; D01F 6/60; D01F 6/62; D01F 6/70

(52) U.S. Cl. CPC D01F 1/10; B32B 5/024; B32B 5/026; B32B 5/26; B32B 5/263; B32B 37/16; C08J 3/22; C08K 3/04; C09C 1/482; D01D 5/04; D01D 5/082; D01F 6/60; D01F 6/62; D01F 6/70; B32B 2250/20; B32B 2262/0261; B32B 2262/0276; B32B 2262/0292; B32B 2305/186; B32B 2305/188; B32B 2367/00; B32B 2375/00; B32B 2377/00; B32B 2437/00; D10B 2501/00; D10B 2501/04

(57) ABSTRACT

A process for making a garment from a recycled dope-dyed synthetic yarn comprises the incorporation of a recycled carbon black into the yarn for making an environmentally friendly garment for lowering emission of carbon dioxide.

### BACKGROUND OF THE INVENTION

There is a tendency to make a sportwear by incorporating recycled ingredients or additives in the clothing as recommended by GRS (Global Recycled Standard). The GRS provides independent verification that products claiming to be made from recycled materials are genuine, and that responsible social, environmental and chemical practices have been followed in their manufacture. Business whose products achieve the GRS has shown the highest standards in consideration of the environmental issues throughout the supply chain for that product.

For making sportwear, an additive such as a delustrant of titanium dioxide may be used. However it can not be defined as an environmentally friendly ingredient, and is therefore unable to conform to the GRS standard.

Accordingly, it is intended to invent a black garment by adding a recycled carbon black into the polymer from which the recycled dope-dyed yarn is spun. Subsequently, the yarn consisting of 100% recycled materials is knitted (or woven) into garment in order to be conforming to the GRS standard.

### SUMMARY OF THE INVENTION

The object of the present invention is to provide a garment, particularly a diving suit or wet suit, including the incorporation of recycled carbon black in the garment in order to reduce the emission of carbon dioxide to thereby be environmentally friendly.

### BRIEF DESCRIPTION OF THE DRAWINGS

FIG. 1 is a flow sheet showing the process steps in accordance with the present invention.

### DETAILED DESCRIPTION

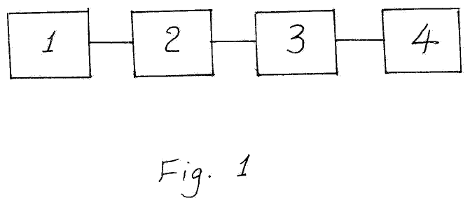

As shown in FIG. 1, the process for making garments of the present invention comprises the following steps:

1. Preparation of Spinning Polymer:

A masterbatch is made by incorporating recycled carbon black, which has been ground to be less than 3 microns of particle size, into a carrier polymer to form a masterbatch (100% by weight) containing the recycled carbon black (20% by weight) and the carrier polymer (80% by weight). Then, the masterbatch is mixed with a chip polymer to be a spinning polymer (100% by weight) containing: masterbatch, 1˜20% (by weight); and chip polymer, 99˜80% (by weight).

The recycled carbon black is preferably made from pyrolysis of waste tire. Such a recycled carbon black has a low emission of carbon dioxide of 1.065 kg/kg of recycled carbon black, which is very environmentally friendly and eco-sustainable. The recycled carbon black may be partially replaced with regular carbon black.

The recycled carbon black shall be ground to have a particle size less than 3 microns when used in this invention.

The chip polymer may include Nylon and Polyester. The Polyurethane polymer may include two types of process: One is dry-spinning process, the other is melt-spinning process. These polymer may be spun into recycled dope-dyed black yarns of the following specifications:
Nylon: 20D˜140D
Polyester: 20D˜150D
Spandex: 20D˜140D

2. Yarn Making

The spinning polymer of Nylon, Polyester, etc. is then extruded and spun to be a POY yarn (partially-oriented yarn) via melt-spinning process, and is further twisted by a false twister to form a DTY yarn (draw texturing yarn).

The spinning polymer of Nylon, Polyester, etc. may also be drawn to be a fully drawn yarn (FDY), being different from the afore-mentioned partially-oriented yarn (POY).

The Polyurethane polymer with solvent is spun into Spandex yarns via dry-spinning, while the one without solvent is spun into yarns via melt-spinning process.

3. Fabric Fabrication:

The yarn thus obtained may be knitted (or woven) to be a fabric. The fabric is then processed, including: scouring and heat setting, adapted for the next step of the present invention.

4. Garment Formation:

The fabric is made as a garment, including: apparel, sportwear, wet suit and other clothings.

Since the garment is made from recycled dope-dyed synthetic yarn by incorporating recycled carbon black therein, it may eliminate the dyeing process to save water, dyestuff, auxiliary, and energy, and may lower the emission of carbon dioxide to obtain a product made of 100% recycled materials.

When making a wet suit, a plurality of fabric layers (including outside and inside layers) may be laminated together by choosing the desired yarn for each layer.

The present invention discloses a novel garment by incorporating the recycled carbon black in the garment, especially a diving suit or wet suit, to have the following advantages:

The recycled carbon black has a lower CO₂ emission of 1.065 kg of CO₂/kg of recycled carbon black, which is superior to the CO2 emission by regular carbon black made from fossil fuel or coal tar of 3.5 kg of CO₂/kg of regular carbon black. This is very environmentally friendly and eco-sustainable, since the goal of making garments with 100% recycled materials is finally achieved.

It may meet the GRS standard for better environmental protection.

I claim:

1. A process for making a garment comprising the steps of:
a. Preparation of spinning polymer:
a masterbatch being made by incorporating a recycled carbon black, which has been ground to be less than 3 microns of particle size, into a carrier polymer to form a masterbatch 100% (by weight) containing the recycled carbon black 20% (by weight) and the carrier polymer 80% (by weight); said masterbatch being mixed with a chip polymer to be a spinning polymer 100% (by weight) containing: said masterbatch, 1˜20% (by weight) and said chip polymer 99˜80% (by weight);
b. Yarn making:
said spinning polymer then processed to be a yarn;
c. Fabric fabrication:
said yarn being knitted or woven to be a fabric; and then processed, including: scouring and heat setting; and
d. Garment formation:
said fabric being formed as a garment, including: apparel, sportwear, and wet suit.

2. The process according to claim 1, wherein said recycled carbon black is made from pyrolysis of waste tire.

3. The process according to claim 2, wherein said recycled carbon black is partially replaced with a regular carbon black.

4. The process according to claim 1, wherein said chip polymer includes: Nylon, polyester and polyurethane (Spandex).

5. The process according to claim 4, wherein said chip polymer is spun into a recycled dope-dyed black yarn having the following specification:
Nylon: 20D˜140D; or
Polyester: 20D˜150D: or
Spandex: 20D˜140D.

6. The process according to claim 1, wherein said spinning polymer as disclosed in step b is formed as a yarn through a process as selected from the following:
a. A spinning polymer of Nylon or polyester being extruded and spun to be a partially oriented yarn (POY) by a melt-spinning process, and further twisted to be a drawtexturing yarn (DTY);
b A spinning polymer of Nylon or polyester being drawn to be a fully drawn yarn (FDY); and
c. A spinning polymer of polyurethane (PU) being spun into a spandex yarn.

7. The process according to claim 6, wherein said spinning polymer of PU, with a solvent, is spun into a spandex yarn through a dry-spinning process.

8. The process according to claim 6, wherein said spinning polymer of PU, without a solvent, is spun into a spandex yarn through a melt-spinning process.

9. The process according to claim 1, wherein said wet suit of said garment is formed by laminating a plurality of layers of said fabric together to form said wet suit.
